(19) United States
(12) Patent Application Publication
(10) Pub. No.: US 2025/0065893 A1
(43) Pub. Date: Feb. 27, 2025

(54) METHOD FOR SUPERVISING THE OPERATION OF A MOTOR VEHICLE

(71) Applicant: AMPERE S.A.S., Boulogne Billancourt (FR)

(72) Inventors: Hussam ATOUI, Guyancourt Cedex (FR); John Jairo MARTINEZ, Grenoble (FR); Vincente MILANES, Valladolid (ES); Olivier SENAME, Saint Martin d'Hères (FR)

(73) Assignee: AMPERE S.A.S., Boulogne Billancourt (FR)

(21) Appl. No.: 18/719,287

(22) PCT Filed: Dec. 12, 2022
(86) PCT No.: PCT/EP2022/085294

§ 371 Date: Jun. 13, 2024

(30) Foreign Application Priority Data
Dec. 14, 2021 (FR) FR2113515

(51) Int. Cl. B60W 50/06; B60W 60/00

(52) U.S. Cl. CPC B60W 50/06; B60W 60/001; B60W 2556/65; B60W 2756/10

(57) ABSTRACT

A method supervises the operation of a motor vehicle included an ordered set of at least two automated systems. The method includes activating the supervision of the ordered set of automated systems and iterations of supervising an automated system. Each iteration is applied successively, according to the order of the ordered set, to one of the automated systems. The supervising including measuring a performance of the automated system being supervised, and optionally assigning a positive, negative, or zero score to the automated system being supervised on the basis of the measured performance. The method also includes updating at least one automated system of the ordered set on the basis of the score assigned to the at least one automated system

The invention relates to a method for supervising operation of a motor vehicle. The invention also relates to a device for supervising operation of a motor vehicle. The invention also relates to a computer program implementing the aforementioned method. The invention lastly relates to a recording medium on which such a program is recorded.

Development of autonomous vehicles has made it necessary to be able to guarantee the safety of the automated systems employed in this type of vehicle. This in particular implies the ability to evaluate the effectiveness of automated systems in any type of situation, including critical situations such as sudden lane changes, collision avoidance, sensor failure, aggressive maneuvers by surrounding vehicles, etc.

Document US20200174471 discloses a method for evaluating the performance of an autonomous vehicle by analyzing the overall behavior of the vehicle relative to its environment, this method using a reinforcement learning algorithm by way of reward system.

However, this solution has drawbacks. In particular, the overall nature of the evaluation of behavior of the vehicle prevents the sub-system or sub-systems that could be the cause of a malfunction from being pinpointed.

The aim of the invention is to provide a device and method for supervising operation of a motor vehicle that remedy the above drawbacks and that improve on the supervising devices and methods known in the prior art. In particular, the invention makes it possible to provide a device and method that are simple and reliable and that allow the sub-system or sub-systems that are the cause of a malfunction to be pinpointed.

To this end, the invention relates to a method for supervising operation of a motor vehicle comprising an ordered set of at least two automated systems. The method comprises:
a first step of activating supervision of the ordered set of automated systems,
iterations of a second step of supervising an automated system, each iteration being applied successively, in the order of the ordered set, to one of the automated systems, the second step comprising:
   a sub-step of measuring a performance of the automated system under supervision, and optionally,
   a sub-step of assigning a positive, negative or zero score to the automated system under supervision depending on the measured performance,
and,
a third step of updating at least one automated system of the ordered set depending on the score assigned to the at least one automated system.

In one embodiment, iterations of the supervising second step are interrupted when an automated system obtains a negative score.

In one embodiment, the ordered set of at least two automated systems is formed, in order, of the following systems: a system for controlling movement of the vehicle, then a decision-making system, then a system for processing perception data.

In one embodiment, the motor vehicle comprises communication systems including vehicle-to-vehicle communication systems and/or vehicle-to-infrastructure communication systems, the motor vehicle further being equipped with a human-machine interface,

and the first step of activating supervision comprises receiving an evaluation of a behavior of the motor vehicle either from the human-machine interface or from the communication systems.

In one embodiment, the method comprises, following receipt of an evaluation of a behavior from the communication systems,
determining that the vehicle is being controlled in a first way if the vehicle is being controlled by a human driver, or determining that the vehicle is being controlled in a second way if the vehicle is being controlled by the set of at least two automated systems, then
if the vehicle is controlled in the first way, transmitting, to the human-machine interface, a score assigned to the human driver, the score being determined based on the evaluation of the behavior of the motor vehicle.

In one embodiment, the third step of updating at least one automated system comprises implementing a reinforcement learning algorithm or a switching system.

The invention further relates to a device for supervising operation of a motor vehicle, the vehicle being equipped with an ordered set of at least two automated systems. The device comprises hardware and/or software elements implementing the method such as defined above, in particular hardware and/or software elements designed to implement the method such as defined above, and/or the device comprises means for implementing the method such as defined above.

The invention also relates to a computer program product comprising program code instructions recorded on a computer-readable medium for implementing the steps of the method such as defined above when said program is run on a computer. The invention also relates to a computer program product that is downloadable from a communication network and/or recorded on a data medium that is readable by a computer and/or executable by a computer, comprising instructions that, when the program is executed by the computer, lead the latter to implement the method such as defined above.

The invention also relates to a computer-readable data recording medium on which is recorded a computer program comprising program code instructions for implementing the method such as defined above. The invention also relates to a computer-readable recording medium comprising instructions that, when they are executed by a computer, cause the latter to implement the method such as defined above.

The invention also relates to a signal of a data carrier, carrying the computer program product such as defined above.

The appended drawing shows, by way of example, one embodiment of a supervising device according to the invention and one mode of execution of a supervising method according to the invention.

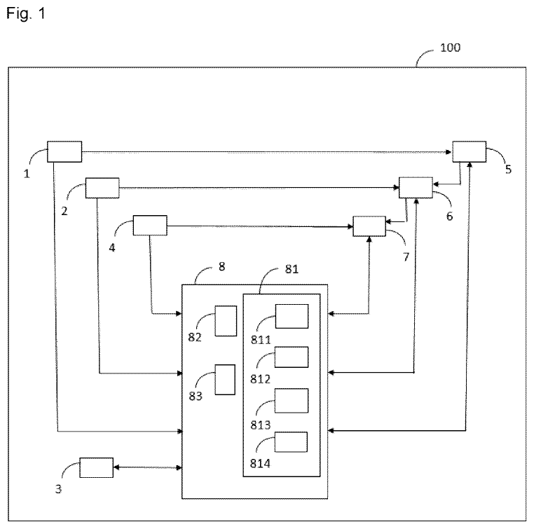

FIG. 1 shows a motor vehicle equipped with a supervising device.

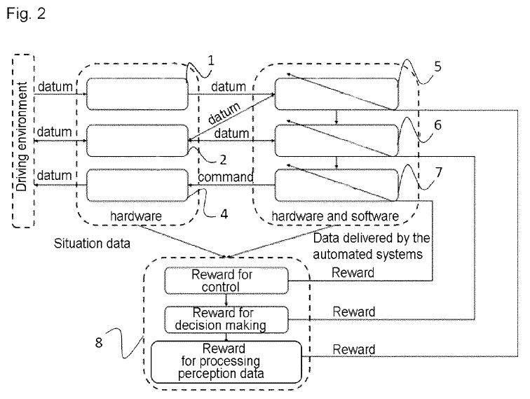

FIG. 2 is an alternative representation of a motor vehicle equipped with a supervising device.

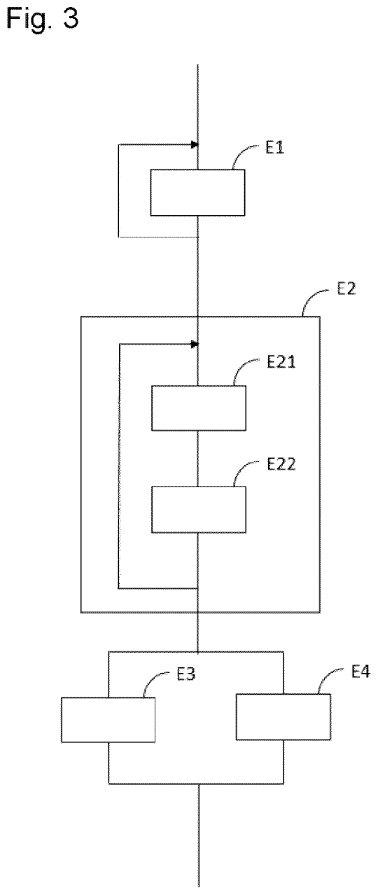

FIG. 3 shows a flowchart of a mode of execution of a supervising method.

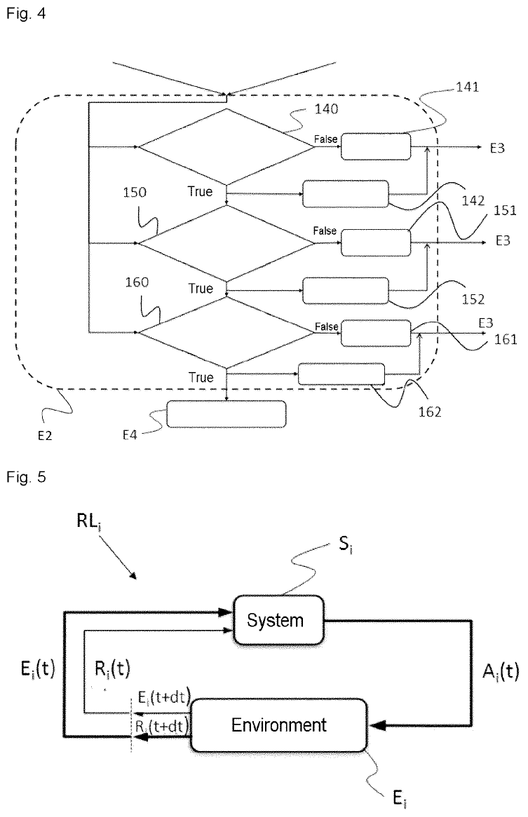

FIG. 4 is an alternative representation of a mode of execution of a supervising method.

FIG. 5 illustrates the principle of a reinforcement learning algorithm.

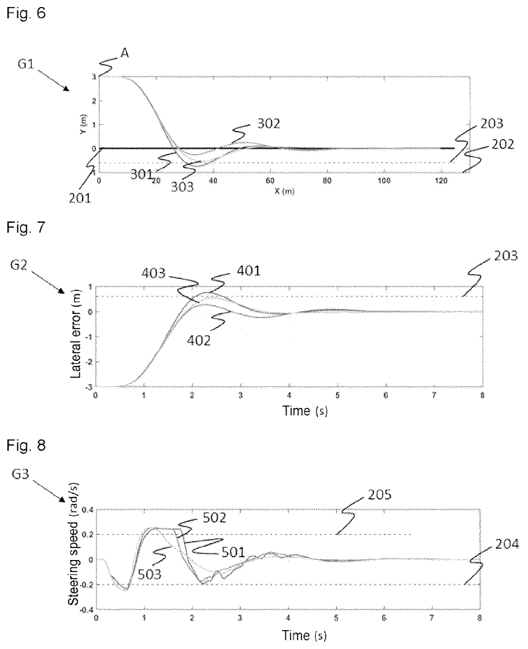

FIG. 6 is a first illustration of a given example of implementation of a supervising method.

FIG. 7 is a second illustration of the given example of implementation of a supervising method.

FIG. 8 is a third illustration of the given example of implementation of a supervising method.

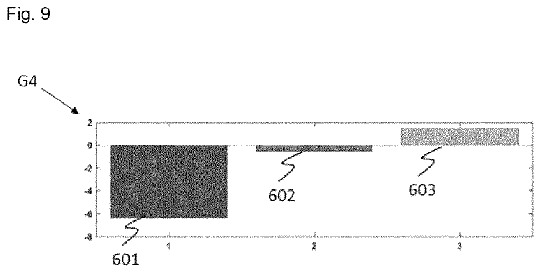

FIG. 9 is a fourth illustration of a given example of implementation of a supervising method.

One example of a motor vehicle 100 equipped with one embodiment of a device for supervising operation of a motor vehicle will now be described with reference to FIG. 1.

The motor vehicle 100 may be a motor vehicle of any type, in particular a passenger vehicle, a commercial vehicle, a truck or even a means of public transport such as a bus or a shuttle. According to the described embodiment, the motor vehicle 100 is an autonomous vehicle and will be designated the “autonomous vehicle” in the remainder of the description.

This illustration is therefore given non-limitingly. In particular, the motor vehicle could be a non-autonomous vehicle equipped with an advanced driver-assistance system, in particular an advanced driver-assistance system corresponding to a level greater than or equal to level 2 autonomy, i.e. corresponding to a partially autonomous vehicle.

The autonomous vehicle 100 mainly comprises the following elements:
sensors 1 of the environment of the autonomous vehicle 100,
communication systems 2,
a human-machine interface 3,
actuators 4 of the motor vehicle,
a system 5 for processing perception data,
a decision-making system 6,
a system 7 for controlling movement of the vehicle,
a computing unit 8, comprising a microprocessor 81, a local electronic memory 82 and communication interfaces 83 allowing the microprocessor 81 to communicate with the sensors 1, the communication systems 2, the human-machine interface 3, the system 5 for processing perception data, the decision-making system 6 and the system 7 for controlling movement of the vehicle.

The sensors 1 of the environment of the autonomous vehicle 100 may comprise a set of cameras and/or lidars and/or radars for observing the environment all the way around, i.e. 360 degrees around, the autonomous vehicle 100. They may further comprise a GPS and an inertial measurement unit, which are used to locate the autonomous vehicle 100. The data delivered by the sensors 1 are transmitted to the system 5 for processing perception data.

The communication systems 2 comprise vehicle-to-vehicle communication systems (V2V systems) or vehicle-to-infrastructure communication systems (V2i systems) allowing vehicles to exchange information with one another and with infrastructure, in particular information regarding meteorological conditions.

The human-machine interface 3 is intended for the driver or user of the autonomous vehicle 100. It allows the driver or user of the autonomous vehicle 100 to evaluate the behavior of her or his own vehicle or a surrounding vehicle. It also makes it possible to inform the driver of the vehicle when responsibility for controlling her or his vehicle has been assigned thereto following failure of at least one automated system.

The actuators 4 effect the movement of the autonomous vehicle 100; they comprise an engine/motor torque actuator, a brake actuator and an actuator of rotation of the steered wheels.

The system 5 for processing perception data processes the data delivered by the sensors 1 and by the communication systems 2, and constructs a representation of the environment of the autonomous vehicle 100. The system 5 delivers as output the position of the vehicle and a description of all the relevant objects surrounding it.

The decision-making system 6 receives the data delivered by the system 5 for processing perception data, which inform it of the current situation of the vehicle and of its environment. Depending on these data, the system 6 adapts the behavior of the vehicle to the present situation. In particular, the system 6 may determine a decision of the autonomous vehicle 100, relating for example to a lane change maneuver, and/or to remaining in lane with a change of speed.

The system 6 comprises a navigation system the role of which is to generate the motion and to plan the behavior of the vehicle. It acts before the system 7 for controlling movement of the vehicle, to adapt the response of the vehicle to current scenarios.

The system 7 for controlling movement of the vehicle consists mainly of a longitudinal control sub-system, a lateral control sub-system and the chassis. The system 7 generates commands with a view to minimizing an error between the actual path of the vehicle and the path defined by the navigation system, for example for the purposes of lane keeping, speed tracking, etc.

The system 5 for processing perception data, the decision-making system 6 and the system 7 for controlling movement of the vehicle are capable of receiving rewards or scores from the microprocessor 81.

In the described embodiment, the autonomous vehicle 100 therefore comprises an ordered set ENS of automated systems, the ordered set comprising, in order, the following systems: the system 7 for controlling the movement of the vehicle, then the decision-making system 6, then the system 5 for processing perception data.

FIG. 2 is an alternative representation of a motor vehicle equipped with a supervising device according to the invention.

In the embodiment of the invention, the computer 81 makes it possible to execute a software package comprising the following modules, which communicate with one another:
a module 811 for activating supervision, which communicates with the communication systems 2, the human-machine interface 3 and the local memory 82,
a module 812 for supervising an automated system, which communicates with the system 5 for processing perception data, the decision-making system 6, the system 7 for controlling movement of the vehicle, and the local memory 82,
a module 813 for updating an automated system, which communicates with the system 5 for processing perception data, the decision-making system 6, the system 7 for controlling movement of the vehicle, and the local memory 82,
a module 814 for transferring the task of driving to a human driver, which interacts with the human-machine interface 3 and the local memory 82.

One mode of execution of the method for controlling an autonomous vehicle will now be described with reference to FIG. 3. The method comprises four steps E1 to E4.

In a first step E1, supervision of the ordered set ENS of automated systems is activated.

In a first embodiment, activation of supervision is automatic. For example, it occurs on start-up of the autonomous vehicle 100, then the set of sub-systems is periodically supervised, with a period P that may be set or dependent on the navigation context of the vehicle.

In the first embodiment of step E1, it is for example possible to use a time delay TEMPO associated with step E1. The time delay is recorded in the local memory 82. It may take two states: a state called the inactive state, and a state called the active state. By default the time delay is in the inactive state. When a time delay is started, it enters the active state. Next, when the time delay has elapsed, the time delay enters the inactive state.

In the first embodiment of step E1, the state of the time delay TEMPO is tested.

If the time delay is inactive, then the time delay TEMPO is activated and assigned a duration P corresponding to the supervision period. The time delay then enters the active state for a time P. Step E2 is then passed to.

In a second embodiment, which is complementary or an alternative to the first embodiment, activation of supervision may comprise receipt of an evaluation of a behavior of the autonomous vehicle 100 delivered by either the human-machine interface 3 or the communication systems 2.

In other words, an evaluation of a behavior of the autonomous vehicle 100 has been issued
either by a driver or passenger of the autonomous vehicle 100 via the human-machine interface 3,
or by a driver or passenger of a surrounding vehicle or by a surrounding piece of infrastructure, the evaluation being received via the communication systems 2.

In the second embodiment, the way in which the vehicle 100 is being controlled is evaluated. Advantageously, the way in which the vehicle is being controlled is recorded in the local memory 82 and kept up to date. The vehicle 100 may be being controlled
in a first way T1 if the vehicle is being controlled by a human driver,
or in a second way T2 if the vehicle is being controlled by the set ENS of at least two automated systems.

If the vehicle is being controlled in the first way T1, this means that the evaluation of a behavior of the vehicle is meant for a human driver of the vehicle. A score is then assigned to the human driver depending on the evaluation of the behavior EC. It is transmitted to her or him via the human-machine interface 3. Step E1 is then returned to.

If the vehicle is being controlled in the second way T2, this means that the evaluation of a behavior of the vehicle must be analyzed depending on the automated systems of the set ENS. Step E2 is then passed to.

In the second step E2, the automated systems of the set ENS are successively supervised, the order of supervision of the systems being set. In the embodiment of the set ENS described, this amounts to supervising first the system 7 for controlling movement of the vehicle, then the decision-making system 6, then the system 5 for processing perception data.

Supervision of an automated system Sᵢ comprises two sub-steps:
a sub-step E21 of measuring a performance Pᵢ of the automated system Sᵢ, and optionally,
a sub-step E22 of assigning a positive, negative or zero score Nᵢ to the automated system Sᵢ depending on the measured performance Pᵢ.

In the remainder of the document, the terms “score” or “reward” are used interchangeably to designate a numerical evaluation of the operation of an automated system Sᵢ.

The processing operations performed in sub-steps E21 and E22 depend on the evaluated sub-system Sᵢ. Sub-steps E21 and E22 are iterated on the various systems Sᵢ.

For example, with regard to supervision of the system 7 for controlling movement of the vehicle, in sub-step E21, it is possible to compute a difference between a first path applied by the autonomous vehicle 100 and an ideal second path determined beforehand by the decision-making module 6. In sub-step E22, a positive, negative or zero score is assigned depending on the computed deviation.

With regard to supervision of the decision-making system 6, in sub-step E21, it is possible to verify whether a decision defined by the decision-making module 6 meets the constraints determined by the perceiving system 5. For example, it is possible to check whether the decision respects the configuration of the surrounding traffic, the state of traffic lights, etc. Next, in sub-step E22, if the decision respects the configuration of the surrounding traffic, then a positive or zero score is assigned to the decision-making module 6. Otherwise, a negative score is assigned to the decision-making module 6.

With regard to supervision of the perceiving system 5, in sub-step E21, it is possible to check the consistency between current perceptions delivered by the perceiving system 5 at supervision time T, and the perceptions delivered by the perceiving system 5 at a previous time T−dT. For example, it is possible to check whether ghost tracks have appeared between the times T−dT and T, or it is possible to detect an uncertainty in the location of a vehicle or of an object between the times T−dT and T. It is moreover possible to detect images that are degraded due to poor meteorological conditions. Next, in sub-step E22, depending on the results of sub-step E21, a positive or negative or zero score is assigned to the perceiving system.

Thus, each automated system Sᵢ supervised in step E2 obtains a positive, negative or zero score Nᵢ. In one embodiment, the scores Nᵢ obtained are recorded in the local memory 82 in order to be processed during the subsequent execution of step E3 of updating at least one automated system Sᵢ.

In addition, in one preferred embodiment, iteration of the second step E2 is interrupted as soon as an automated system Sᵢ obtains a negative score Nᵢ. This preferred embodiment of step E2 is illustrated by FIG. 4 and described below.

In a first step 140, it is tested whether the system 7 for controlling movement of the vehicle has achieved its objectives:
if yes, in a second step 142, a neutral reward is transmitted to the system 7; then the method passes to a third step 150, and
if not, in a fourth step 141, a negative reward is transmitted to the system 7 and step E3 is passed to directly.

In the third step 150, it is tested whether the decision-making system 6 has achieved its objectives:
if yes, in a fifth step 152, a neutral reward is transmitted to the system 6; then a sixth step 160 is passed to, and
if not, in a seventh step 151, a negative reward is transmitted to the system 6 and step E3 is passed to directly.

In the sixth step 160, it is tested whether the sensors 1 are faulty:
if not, in an eighth step 161, a negative reward is transmitted to the system 5 for processing perception data and step E3 is passed to directly,
if yes, in a ninth step 162 a neutral reward is transmitted to the system 5; then step E4 of transferring the task of driving to a human driver is passed to.

Thus, during the iteration of step E2 applied to the system 7 for controlling movement of the vehicle, if the system 7 for controlling movement of the vehicle obtains a negative score, the step E3 of updating the system 7 for controlling movement of the vehicle is passed to directly without performing supervision either of the decision-making system 6 or of the perceiving system 5.

Likewise, if, during the iteration of step E2 applied to the decision-making system 6, the decision-making system 6 obtains a negative score, step E3 of updating the decision-making system 6 is passed to directly without performing supervision of the perceiving system 5.

When a negative evaluation of a behavior of the autonomous vehicle 100 (delivered by the human-machine interface 3 or by the communication systems 2) has been processed in step E1, it is expected that in step E2 it will be determined which automated system Sᵢ was the origin of the negatively evaluated behavior. However, it may happen that no automated system Sᵢ receives a negative score during execution of step E2. Thus, the situation is then one in which the supervision of the systems performed in step E2 determines no possible source of the behavior of the autonomous vehicle, and therefore no means of correcting the negatively evaluated behavior. In this case, step E4 of transferring the task of driving to a human driver is passed to.

In step E3, at least one automated system Sᵢ of the ordered set ENS is updated depending on a score Nᵢ assigned to the at least one automated system Sᵢ.

Step E3 comprises implementing an adaptation of each automated system Sᵢ that obtained a score Nᵢ during execution of step E2. In one embodiment, the adaptation comprises implementing a reinforcement learning algorithm RLᵢ and/or the adaptation comprises implementing a switching system SWᵢ.

In the remainder of the document, the term “adaptation” of a system Sᵢ designates training or improving or updating the system Sᵢ by taking into account a score Nᵢ obtained during execution of step E2.

FIG. 5 illustrates the principle of a reinforcement learning algorithm RLᵢ applied to a system Sᵢ undergoing training. In each cycle, the system Sᵢ receives information on the state of an environment Eᵢ(t), comprising a dataset describing a current situation. On the basis of this information, the system Sᵢ selects an action to be executed Aᵢ(t), which modifies the state of the environment (the new state being Eᵢ(t+dt)) and generates a reward Rᵢ(t+dt) for the system Sᵢ. The objective of such an algorithm is to maximize the reward Rᵢ after a certain number of iterations of the algorithm.

As a variant, the learning algorithm RLᵢ could use a learning method of the Q-Learning type, which allows the system Sᵢ to learn a strategy to determine which action Aᵢ to perform in each state Eᵢ of the system. It functions by learning a function Qᵢ that makes it possible to determine the potential gain, Qᵢ(Eᵢ(t),Aᵢ(t)), i.e. the long-term reward gained by choosing an action Aᵢ(t) in a state Eᵢ(t) in accordance with an optimal policy. One of the advantages of the Q-learning method is that it does not depend on the definition of an evolution model or control strategy defined beforehand by the user, but is based directly on the interaction of the system with its environment and the reward received in each step.

Thus, when adaptation of an autonomous system Sᵢ comprises implementing a learning algorithm RLᵢ, the positive or zero score obtained by an automated system Sᵢ during execution of step E2 makes it possible to improve the robustness of the system, in particular by saving to the local memory 82 the parameters of the system Sᵢ that were applied during the scenario associated with obtainment of the positive or zero score, in particular by saving the data received as input by the system and the data delivered as output by the system Sᵢ.

Alternatively, adaptation of an autonomous system Sᵢ may comprise implementing a switching system SWᵢ. A switching system SWᵢ consists of a set of sub-systems SSWᵢₖ and of a logical law Lᵢ (or switching controller Lᵢ) that indicates which sub-system SSWᵢₖ is active.

In one embodiment, a Q-learning algorithm could interact with a switching controller Lᵢ designed to supervise the switching system SWᵢ.

The choice between a first type of adaptation, implementing a reinforcement learning algorithm RLᵢ, and a second type of adaptation, implementing a switching system SWᵢ, may be guided by the need for the system Sᵢ to exhibit stability. For example, in the case of a system 7 for controlling movement of the vehicle 7, it is essential for the system to exhibit stability for reasons of safety of the movement of the vehicle. In this case, an adaptation of the second type will preferably be used, i.e. an adaptation implementing a switching system SWᵢ.

Alternatively, when the system Sᵢ to be adapted manages a large number of data, it may be more advantageous to use an adaptation of the first type, i.e. one implementing a reinforcement learning algorithm RLᵢ. For example, it is particularly advantageous to use a reinforcement learning algorithm to adapt the decision-making system 6. Specifically, this type of algorithm makes it possible to manage a large number of physical and measured data, then to evaluate relationships between data describing the environment of the vehicle and a decision made by the decision-making system 6.

In other words, the complexity of the task of driving and the unpredictability of the environment make it difficult to model the current situation and the risk associated therewith. Reinforcement learning algorithms RLᵢ offer an alternative solution to modeling; they allow the increasing complexity of the system to be managed through provision of an intermediate solution comprising an exploratory processing first part, and a processing second part for exploiting data, the first and second parts together making it possible to infer a behavior of the system Sᵢ.

One example of implementation of a supervising method according to the invention is illustrated in FIGS. 6 to 9. The simulation described relates to an autonomous lane change by the autonomous vehicle 100.

The graph G1 of FIG. 6 shows
on the x-axis, the longitudinal distance expressed in meters travelled by the autonomous vehicle 100 from the start of the maneuver, and
on the y-axis, the lateral distance expressed in meters between the position 301, 302, 303 of the autonomous vehicle and the target path 201.

The target path 201 is represented by the straight line Y=0 in the graph G1.

The autonomous vehicle 100 initiates a lane change maneuver when it is located at a lateral distance from the target path 201 equal to 3 meters, as represented by point A in FIG. 6.

The system 5 for processing perception data identifies the presence of a truck located at a y-coordinate 202 equal to −1 meter, i.e. at a lateral distance of 1 meter from the target path and at a lateral distance of 4 meters from the autonomous vehicle 100 at the start of the maneuver (i.e. at point A).

On the basis of the information delivered by the system 5 for processing perception data, the decision-making system 6 transmits to the movement-controlling system 7
a first setpoint imposing a minimum lateral-distance limit 203 between the target path 201 and the autonomous vehicle 100 equal to −0.6 m, and
a second setpoint guaranteeing driving comfort by limiting the absolute value of the steering speed to 0.2 radians per second.

Depending on the setpoints determined by the decision-making system 6, the objective of the movement-controlling system 7 is to follow the path smoothly (in particular by applying a small steering force) while respecting the required lateral constraints.

Consequently, in the iteration of the supervising step E2 applied to the movement-controlling system 7, and more particularly in sub-step E21, the system 7 is evaluated according to the following criteria:
a first criterion according to which the autonomous vehicle 100 must not exceed the limit 203 corresponding to a lateral distance of −0.6 meters between the target path 201 and the position of the autonomous vehicle, as shown in FIG. 7, and
a second criterion according to which the autonomous vehicle must maintain a steering speed between a minimum value 204 equal to −0.2 radians per second and a maximum value 205 equal to 0.2 radians per second, as shown in FIG. 8.

As long as the vehicle meets the first and second criteria,
in sub-step E22, a positive score Nᵢ is assigned to the movement-controlling system 7, and
in step E3, the learning of the system 7 is reinforced by processing the positive score Nᵢ.

In the example illustrated in FIGS. 6 to 9, the learning of the system 7 is based on use of a switching system SWᵢ, which is able to switch between three different versions 71, 72, 73 of the system 7.

FIG. 7 shows, in a graph G2:
the variation as a function of time 401 in the lateral distance in meters between the current position of the autonomous vehicle 100 and the target path when the first version 71 of the system 7 is used,
the variation as a function of time 402 in the lateral distance in meters between the current position of the autonomous vehicle 100 and the target path when the second version 72 of the system 7 is used,
the variation as a function of time 403 in the lateral distance in meters between the current position of the autonomous vehicle 100 and the target path when the third version 73 of the system 7 is used.

FIG. 8 shows, in a graph G3:
the variation as a function of time 501 in the lateral distance in meters between the current position of the autonomous vehicle 100 and the target path when the first version 71 of the system 7 is used,
the variation as a function of time 502 in the lateral distance in meters between the current position of the autonomous vehicle 100 and the target path when the second version 72 of the system 7 is used,
the variation as a function of time 503 in the lateral distance in meters between the current position of the autonomous vehicle 100 and the target path when the third version 73 of the system 7 is used.

FIG. 9 shows, in a graph G4, the score 601, 602, 603 assigned to each of the first, second and third versions 71, 72, 73 of the system 7, respectively.

FIGS. 6 and 7 illustrate the fact that the first version 71 of the system 7 did not allow the autonomous vehicle 100 to respect the lateral limit 203.

In step E22, the first version 71 of the system 7 therefore obtains a highly negative score N₇₁, in particular −6, as is illustrated in FIG. 9.

In step E3, the score N₇₁ is then transmitted to the system 7 which is thus informed that it must be improved.

A second version 72 of the system 7 is then used instead of the first version 71. FIGS. 6 and 7 illustrate the fact that the second version 72 of the system 7 allowed the autonomous vehicle 100 to respect the lateral limit 203. However, FIG. 8 illustrates the fact that the second version 72 exceeded the permitted limit in terms of steering speed 502. In step E22, the second version 72 of the system 7 therefore obtains a slightly negative score N₇₂, as is illustrated in FIG. 9.

In step E3, the score N₇₂ is then transmitted to the system 7 which is thus informed that it must still be improved.

A third version 73 of the system 7 is then used instead of the second version 72. FIGS. 6 and 7 illustrate the fact that the third version 73 of the system 7 allowed the autonomous vehicle 100 to respect the lateral limit 203. In addition, FIG. 8 illustrates the fact that the third version 73 exceeded the permitted limit in terms of steering speed 502 only transitionally. In step E22, the third version 72 of the system 7 therefore obtains a positive score N₇₃, as is illustrated in FIG. 9.

In a step E4, control of the vehicle is transferred to a user of the autonomous vehicle 100. The automated systems Sᵢ are then no longer active. The way in which the vehicle is being controlled is then updated in the local memory 82, i.e. to reflect that the first way T1 is now being used.

Finally, the supervising method according to the invention makes it possible to evaluate, validate and improve any autonomous advanced driver-assistance system (ADAS) or any automated system of an autonomous vehicle.

To this end, the supervising method assigns individual scores (or rewards) to the behavior of each supervised system, these scores potentially being positive or negative. The first effect thereof is to determine the source of a potential malfunction and thus to allow measures to be taken to increase the safety of operation of each supervised system individually. The second effect thereof is to improve operation of each supervised system, through storage of data reflecting the experience of the autonomous vehicle, in particular when a supervised system obtains a positive score. The experience of each supervised system may be capitalized upon through use, for example, of a reinforcement learning algorithm or a switching system.

The supervising method according to the invention may be implemented in various circumstances.

Firstly, supervision may occur during the phase of calibrating the autonomous vehicle, in order to train each automated system of the autonomous vehicle 100 before the vehicle is put on sale.

Secondly, supervision may occur during the everyday use of the autonomous vehicle 100 by a user. Supervision may then be periodic. In addition or alternatively, supervision may be triggered on an ad hoc basis following a negative evaluation of a behavior of the autonomous vehicle 100, the evaluation possibly coming from data delivered by V2V or V2i networks, or from a human-machine interface of the autonomous vehicle 100.

When it generates a positive score, the supervision then makes it possible to take an opportunity to learn from an experience when, for example, a decision made by the autonomous vehicle was particularly well suited to a delicate driving situation.

When it generates a negative score, the supervision signals a problem to be solved and leads to improvement of the supervised system and/or transfer of the task of driving to a user of the autonomous vehicle 100.

The supervising method is also applicable to a human driver of the autonomous vehicle 100. In this case, the supervising method transmits scores to the human driver via a human-machine interface, these scores potentially being determined depending on evaluations delivered by a surrounding vehicle or piece of infrastructure.

The supervising method according to the invention thus has a number of advantages.

Firstly, it improves the performance, reliability and safety of the vehicle, in particular by improving the adaptability of the vehicle to normal and critical situations.

In addition, the supervising method according to the invention allows the vehicle to improve its operation as it is used, by acquiring knowledge of the situations encountered.

The supervising method according to the invention is applicable to any automated system with which the vehicle is equipped. It may also be applied to a human driver of the vehicle.

1-10. (canceled)

11. A method for supervising operation of a motor vehicle comprising an ordered set of at least two automated systems, the method comprising:
activating supervision of the ordered set of automated systems;
iterations of supervising an automated system, each iteration being applied successively, in an order of the ordered set, to one of the automated systems, the supervising comprising measuring a performance of the automated system under supervision; and
updating at least one automated system of the ordered set depending on a score assigned to the at least one automated system.

12. The supervising method as claimed in claim 11, wherein the supervising comprises assigning a positive, negative or zero score to the automated system under supervision depending on the measured performance.

13. The supervising method as claimed in claim 11, wherein the iterations of the supervising are interrupted when the score assigned to one of the automated systems is a negative score.

14. The supervising method as claimed in claim 11, wherein the ordered set of at least two automated systems is formed, in order, of the following systems: a system configured to control movement of the vehicle, then a decision-making system, then a system configured to process perception data.

15. The supervising method as claimed in claim 11, wherein the motor vehicle comprises communication systems including vehicle-to-vehicle communication systems and/or vehicle-to-infrastructure communication systems, the motor vehicle further being equipped with a human-machine interface, wherein the activating supervision comprises receiving an evaluation of a behavior of the motor vehicle either from the human-machine interface or from the communication systems.

16. The supervising method as claimed in claim 15, further comprising, following receipt of an evaluation of a behavior from the communication systems,
determining that the vehicle is being controlled in a first way when the vehicle is being controlled by a human driver, or determining that the vehicle is being controlled in a second way when the vehicle is being controlled by the set of at least two automated systems, then
when the vehicle is being controlled in the first way, transmitting, to the human-machine interface, a score assigned to the human driver, the score being determined based on the evaluation of the behavior of the motor vehicle.

17. The supervising method as claimed in claim 11, wherein the updating at least one automated system comprises implementing a reinforcement learning algorithm or a switching system.

18. A device for supervising operation of a motor vehicle, the vehicle being equipped with an ordered set of at least two automated systems, the device comprising hardware and/or software elements configured to implement the supervising method as claimed in claim 11.

19. A non-transitory computer readable medium storing a program that, when executed by a computer, causes the computer to execute the supervising method as claimed in claim 11.
